(19) United States
(12) Patent Application Publication
(10) Pub. No.: US 2025/0118975 A1
(43) Pub. Date: Apr. 10, 2025

(54) High-Voltage Storage System Having Emergency Cutout for a Bistable Contactor

(71) Applicant: Bayerische Motoren Werke Aktiengesellschaft, Muenchen (DE)

(72) Inventors: Robert ALIG, Germering (DE); Thomas GLAS, Mainburg (DE)

(21) Appl. No.: 18/907,663

(22) Filed: Oct. 7, 2024

(30) Foreign Application Priority Data
Oct. 9, 2023 (DE) 10 2023 127 432.5

(51) Int. Cl. H02J 7/00; H02J 7/34; H02J 9/06

(52) U.S. Cl. CPC H02J 7/0031; H02J 7/0013; H02J 7/0047; H02J 7/345; H02J 9/061; H02J 2207/50; H02J 2310/48

(57) ABSTRACT

A vehicle high-voltage storage system for a high-voltage system includes an interconnected group of a plurality of storage units, wherein each storage unit has at least one storage cell, a high-voltage switching device, by which a current path formed via the storage units can be interrupted, and which has at least one bistable contactor, switchable by a first supply voltage of a low-voltage supply. An emergency low-voltage supply provides the first supply voltage for opening of the at least one bistable contactor in the event of failure of the low-voltage supply. The emergency low-voltage supply includes at least one of the storage units for providing the first supply voltage, and a low-voltage switching device, which can be switched by a second supply voltage, which is smaller than the first supply voltage, for connecting the at least one storage unit to the at least one bistable contactor.

### CROSS REFERENCE TO RELATED APPLICATION

This application claims priority under 35 U.S.C. § 119 from German Patent Application No. DE 10 2023 127 432.5, filed Oct. 9, 2023, the entire disclosure of which is herein expressly incorporated by reference.

### BACKGROUND AND SUMMARY

The invention relates to a high-voltage storage system for a high-voltage system of a motor vehicle. The high-voltage storage system comprises an interconnected group of a plurality of storage units, wherein each storage unit has at least one storage cell. In addition, the high-voltage storage system comprises a high-voltage switching device, by means of which a current path formed via the storage units can be interrupted, and which has at least one bistable contactor, which can be switched by a first supply voltage of a low-voltage supply. The invention also relates to a vehicle electrical system and to a motor vehicle.

The focus of interest here is on high-voltage storage systems or high-voltage batteries used, in particular, as vehicle batteries for electrified motor vehicles, i.e. for fully electric or hybrid vehicles. Such high-voltage storage systems usually have a plurality of interconnected storage units, which can each have a plurality of storage cells connected in series and/or parallel. The high-voltage energy storage system has high-voltage terminals, which can be connected, for example, to high-voltage components, for instance to an electric drive motor or to a charging terminal, of a high-voltage system of the motor vehicle. Thus the interconnected group of storage units can be discharged and/or charged via the high-voltage terminals.

In the event of a fault, for instance if the motor vehicle is involved in an accident, the vehicle high-voltage system must be taken into an intrinsically safe state and de-energized. For this purpose, the high-voltage terminals are connected to the interconnected group of storage units via a high-voltage switching device, which is usually supplied from a low-voltage supply of a vehicle low-voltage system. The high-voltage switching device can have monostable contactors, for example, which are held in a closed state by the low-voltage supply, and open automatically in the event of failure of the low-voltage supply. Such monostable contactors have a high energy consumption because they must be supplied permanently from the low-voltage supply in order to maintain the closed state.

As DE 10 2009 002 018 A1 describes, it is also possible to use bistable contactors, which need to be supplied from the low-voltage supply only for the switching operation, i.e. for opening or closing. The problem with this, however, is that the contactors do not open automatically in the event of failure of the low-voltage supply.

It is an object of the present invention to provide a solution that makes it possible to open in a safe and simple manner a bistable contactor of a high-voltage storage system of a high-voltage system of a motor vehicle in order to provide an intrinsically safe state of the vehicle high-voltage system.

This object is achieved according to the invention by a high-voltage storage system, a vehicle electrical system and a motor vehicle having the features according to the respective independent claims. The subject matter of the dependent claims, the description and the FIGURE relates to advantageous embodiments of the invention.

A high-voltage storage system according to the invention for a high-voltage system of a motor vehicle comprises an interconnected group of a plurality of storage units, wherein each storage unit has at least one storage cell. A current path formed via the switching units can be interrupted by means of a high-voltage switching device of the high-voltage storage system. The high-voltage switching device has at least one bistable contactor, which can be switched by a first supply voltage of a low-voltage supply. In addition, the high-voltage storage system has an emergency low-voltage supply for providing the first supply voltage for the opening of the at least one bistable contactor in the event of failure of the low-voltage supply. The emergency low-voltage supply comprises at least one of the storage units for providing the first supply voltage and a low-voltage switching device, which can be switched by a second supply voltage, which is smaller than the first supply voltage, for connecting the at least one storage unit to the at least one bistable contactor.

The invention also relates to a vehicle electrical system for a motor vehicle, which has a high-voltage system containing a high-voltage storage system according to the invention and has a vehicle low-voltage system having a low-voltage supply, wherein the low-voltage supply is electrically connected to the at least one bistable contactor of the high-voltage switching device of the high-voltage storage system. A motor vehicle according to the invention comprises a vehicle electrical system according to the invention. The motor vehicle is in particular an electrified motor vehicle, and has the high-voltage storage system as the electric vehicle battery.

The high-voltage storage system comprises the interconnected group of storage units or battery units. Each of the storage units can comprise a storage cell or an interconnected group of a plurality of storage cells. For example, each storage unit can comprise a parallel circuit composed of a plurality of series-connected storage cells. Poles of the high-voltage storage system, i.e. terminals of the interconnected group, are connected to high-voltage terminals of the high-voltage storage system, which terminals can be electrically connected to high-voltage components of the vehicle high-voltage system, for instance to an electric drive motor, to an air-conditioning compressor, to a charger connection, etc. Electrical energy can be taken from, and/or fed to, the high-voltage storage system via the high-voltage terminals. In order to be able to de-energize the vehicle high-voltage system in the event of a fault, the current path formed via the storage units is interrupted. For this purpose, the high-voltage switching device can be connected to at least one of the high-voltage terminals and to the interconnected group, and hence can disconnect the at least one of the high-voltage terminals from the interconnected group. For example, the high-voltage switching device has in particular two bistable contactors, wherein in particular each bistable contactor is connected to one of the poles and to one of the high-voltage terminals. It is also possible for the high-voltage switching device to be located between two storage units and to interrupt the interconnected group of storage units in order to interrupt the current path.

The at least one bistable contactor can be switched by applying the first supply voltage of the low-voltage supply. For example, the low-voltage supply can comprise a low-voltage source of the vehicle low-voltage system, to which source the at least one bistable contactor is electrically connected. For example, the at least one bistable contactor can be connected to a battery control module of the high-voltage storage system, which module is supplied with energy from the low-voltage source of the vehicle low-voltage system, with the result that the first supply voltage is fed to the at least one bistable contactor via the battery control module.

The first supply voltage is needed solely for switching, i.e. for changing the switching state, but not for holding a switching state. The at least one bistable contactor can be a contactor which is driven by an electric motor and which can be taken out of the one switching state into the other switching state by applying the first supply voltage with suitable polarity, or can be a contactor having at least two energizable coils, with each coil being used to establish a switching state. If the low-voltage supply fails, for example as a result of failure of the vehicle low-voltage system and/or the battery control module, and if the first supply voltage thereby ceases to exist, then a switchover of the bistable contactor is no longer possible.

In order to be able to de-energize the vehicle high-voltage system even when the normal low-voltage supply fails, the high-voltage storage system has the emergency low-voltage supply. The emergency low-voltage supply provides a substitute voltage at the level of the first supply voltage, which can be used to open the at least one bistable contactor in an emergency. This substitute voltage is obtained from the interconnected group of storage units and thus from the high-voltage energy storage system itself. This is done by connecting, in the event of failure of the normal low-voltage supply, at least one of the storage units of the interconnected group, for instance via voltage taps on the interconnected group, by means of the low-voltage switching device to the at least one bistable contactor, in particular to both bistable contactors, of the high-voltage switching device. The emergency low-voltage supply is thus formed by at least one storage unit and the low-voltage switching device. The number of interconnected storage units that are used to provide the substitute voltage is selected in particular such that the substitute voltage equals at least the first supply voltage.

The low-voltage switching device in particular has at least one pyrotechnic switching element and/or at least one relay and/or at least one electronic switch and/or at least one multistable switch. The low-voltage switching device preferably has two switching elements, with each switching element being connected to a voltage tap of the interconnected group and to both bistable contactors. The low-voltage switching device can receive the second supply voltage as an emergency cutout trigger. The second supply voltage is lower than the first supply voltage. For example, the first supply voltage equals approximately 12 V and the second supply voltage equals at most 9 V.

For example, the low-voltage switching device can be electrically connected to the low-voltage supply providing the first supply voltage, and can be designed to receive as the second supply voltage a voltage from the low-voltage supply, which voltage collapses on failure of the low-voltage supply. Thus the failing low-voltage supply can switch the low-voltage switching device by supplying to the low-voltage switching device the voltage of the low-voltage supply, which is collapsing as a result of the failure and, although is no longer sufficient for switching the high-voltage switching device, is still sufficient for closing the low-voltage switching device. It can also be provided that the low-voltage supply has a low-voltage energy storage means, for instance a capacitor, for actuating the low-voltage switching device.

Such a high-voltage storage system comprising at least one bistable contactor and an emergency cutout supplied from the high-voltage storage system itself has a particularly energy-efficient and safe design.

In a preferred embodiment, the high-voltage storage system has a cell supervising circuit (CSC), which is electrically connected to voltage taps of the interconnected group for the purpose of voltage measurement. In order to provide the voltage tapped via two of the voltage taps as the first supply voltage, the cell supervising circuit is connected to the at least one bistable contactor via the low-voltage switching device. The cell supervising circuit is designed to monitor the storage cells, which includes measuring and evaluating the voltages of the storage units. For this purpose, the cell supervising circuit is electrically connected to the storage units via the voltage taps, with the energy supply to the cell supervising circuit being provided in particular likewise from the storage cells. This electrical connection between the storage units and the cell supervising circuit is used for the emergency cutout of the at least one bistable contactor by way of the electrical connection between the cell supervising circuit, and thereby at least one of the storage units, and the at least one bistable contactor via the low-voltage switching device. It can also be provided that the cell supervising circuit is designed to provide the second supply voltage for the low-voltage switching device of the emergency low-voltage supply. Thus the cell supervising circuit can also provide the emergency cutout trigger for the low-voltage switching device.

In particular, the cell supervising circuit has input terminals, which are electrically connected to the voltage taps of the interconnected group, and output terminals, which are connected to the low-voltage switching device, wherein the input terminals and the output terminals are galvanically isolated. The cell supervising circuit is designed either to loop through, and provide as the first supply voltage to the at least one bistable contactor, a sub-voltage of the high-voltage storage system, which sub-voltage is provided by the at least one storage unit, or to convert this sub-voltage by means of a galvanically isolated DC-to-DC converter into the first supply voltage and provide this to the at least one bistable contactor. The substitute voltage provided by the at least one storage unit is thus provided to the input terminals, and transferred in converted or unconverted form to the output terminals in a galvanically isolated manner.

The embodiments and their advantages presented with regard to the high-voltage storage system according to the invention apply correspondingly to the vehicle electrical system according to the invention and to the motor vehicle according to the invention.

The claims, the FIGURE and the description of the FIGURE contain further features of the invention. The features and combinations of features mentioned in the description above and the features and combinations of features mentioned below in the description of the FIGURE and/or shown in the FIGURE alone can be used not only in the respectively stated combination, but also in other combinations or alone.

Other objects, advantages and novel features of the present invention will become apparent from the following detailed description of one or more preferred embodiments when considered in conjunction with the accompanying drawings.

### BRIEF DESCRIPTION OF THE DRAWING

FIG. 1 is a circuit diagram of an electrical high-voltage storage system 1 for a high-voltage system of a motor vehicle.

### DETAILED DESCRIPTION OF THE DRAWING

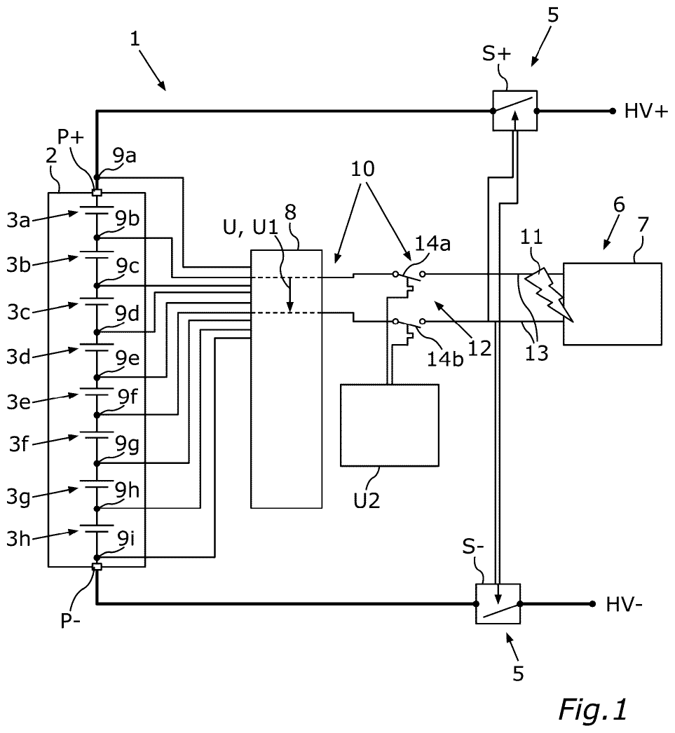

Referring to FIG. 1, the high-voltage storage system 1 has an interconnected group 2, also known as a battery pack, of storage units 3a, 3b, 3c, 3d, 3e, 3f, 3g, 3h, with each of the storage units 3a to 3h having at least one storage cell. The interconnected group 2 has two poles, Pole P+, P−, with the positive pole P+ connected to a first high-voltage terminal HV+, which is on the positive-pole side, and the negative pole P− connected to a second high-voltage terminal HV−, which is on the negative-pole side. The high-voltage terminals HV+, HV− can be electrically connected, for example, to high-voltage loads of the vehicle high-voltage system.

In order to be able to de-energize the vehicle high-voltage system, the high-voltage storage system 1 has a high-voltage switching device 5 containing two bistable contactors S+, S−. A first contactor S+, which is on the positive-pole side, is connected between the positive pole P+ and the first high-voltage terminal HV+. A second contactor S−, which is on the negative-pole side, is connected between the negative pole P− and the second high-voltage terminal HV−. For the purpose of changing the switching state, the contactors S+, S− are supplied with a first supply voltage U1 of a low-voltage supply 6, which here comprises a battery control module 7 of the high-voltage storage system. This battery control module 7 can be supplied with energy from a low-voltage system of the motor vehicle. The high-voltage storage system 1 also has a cell supervising circuit 8 (CSC), which is electrically connected to voltage taps 9a, 9b, 9c, 9d, 9e, 9f, 9g, 9h, 9i of the interconnected group 2 in order to monitor cell voltages of the storage cells.

Since the first supply voltage U1 must be applied to the bistable contactors S+, S− in order for them to perform the switching operations, i.e. to perform the closing and opening, the high-voltage storage system 1 has an emergency low-voltage supply 10, which can provide the first supply voltage in the event of a failure 11 of the low-voltage supply 6. The low-voltage supply 10 here comprises the storage units 3b, 3c, 3d, 3e, which are connected via the voltage taps 9b, 9f to the cell supervising circuit 8 and provide the voltage U. This voltage U corresponds to the first supply voltage and is here looped through the cell supervising circuit 8. This looped-through sub-voltage U can be provided to the bistable contactors S+, S− by means of a low-voltage switching device 12 of the emergency low-voltage supply 10, which is connected to the cell supervising circuit 8 and via a twin-wire line 13 to the bistable contactors S+, S−. The low-voltage switching device 12 has a first switching element 14a, which is connected, in particular at a floating potential via the cell supervising circuit 8, to the voltage tap 9b and to the bistable contactors S+, S−, and a second switching element 14b, which is connected, likewise at a floating potential via the cell supervising circuit 8, to the voltage tap 9f and to the bistable contactors S+, S−. For example, the switching elements 14a, 14b can be pyrotechnic normally-open switches, which can be activated to close the low-voltage switching device 12 by means of a second supply voltage U2.

The second supply voltage U2 is lower than the first supply voltage U1 and can be provided, for example, by the cell supervising circuit 8 or by the failing vehicle low-voltage system 6. Applying the second supply voltage U2 to the switching elements 14a, 14b closes these, and the voltage U is provided to the bistable contactors S+, S−, which are consequently opened and bring about the safe state of the vehicle high-voltage system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A high-voltage storage system for a high-voltage system of a motor vehicle, comprising:
an interconnected group of a plurality of storage units, wherein each storage unit has at least one storage cell;
a high-voltage switching device, by which a current path formed via the plurality of storage units is interruptible, and which has at least one bistable contactor, which is switchable by a first supply voltage of a low-voltage supply; and
an emergency low-voltage supply for providing the first supply voltage for opening of the at least one bistable contactor in an event of failure of the low-voltage supply, wherein
the emergency low-voltage supply comprises at least one of the plurality of storage units for providing the first supply voltage, and a low-voltage switching device, which is switchable by a second supply voltage, for connecting the at least one storage unit to the at least one bistable contactor, and
the second supply voltage is smaller than the first supply voltage.

2. The high-voltage storage system according to claim 1, wherein
the high-voltage switching device has two bistable contactors,
each bistable contactor is electrically connected to a high-voltage terminal of the high-voltage storage system, and via the low-voltage switching device to the at least one storage unit providing the first supply voltage.

3. The high-voltage storage system according to claim 1, wherein
the low-voltage switching device has a pyrotechnic switching element, a relay, an electronic switch, and/or a multistable switch.

4. The high-voltage storage system according to claim 1, further comprising:
a cell supervising circuit electrically connected to voltage taps of the interconnected group for performing voltage measurement,
wherein, in order to provide the first supply voltage, which is tapped via two of the voltage taps, the cell supervising circuit is connected to the at least one bistable contactor via the low-voltage switching device.

5. The high-voltage storage system according to claim 4, wherein
the cell supervising circuit has input terminals, which are electrically connected to the voltage taps of the interconnected group, and output terminals, which are electrically connected to the low-voltage switching device, and
the input terminals and the output terminals are galvanically isolated.

6. The high-voltage storage system according to claim 4, wherein the cell supervising circuit is configured to provide a sub-voltage of the interconnected group, which sub-voltage is provided by the at least one storage unit, by:
(i) looping through, and providing the sub-voltage as the first supply voltage to the at least one bistable contactor, or
(ii) converting, via a galvanically isolated DC-to-DC converter into the first supply voltage, and providing the sub-voltage to the at least one bistable contactor.

7. The high-voltage storage system according to claim 4, wherein
the cell supervising circuit is configured to provide the second supply voltage for the low-voltage switching device of the emergency low-voltage supply.

8. The high-voltage storage system according to claim 1, wherein
the low-voltage switching device is electrically connectable to the low-voltage supply providing the first supply voltage, and is configured to receive, as the second supply voltage, a voltage from the low-voltage supply, which voltage from the low-voltage supply collapses on failure of the low-voltage supply.

9. The high-voltage storage system according to claim 1, wherein
the emergency low-voltage supply has a low-voltage energy store designed to provide the second supply voltage.

10. The high-voltage storage system according to claim 9, wherein
the low-voltage energy store is a capacitor.

11. A vehicle electrical system for a motor vehicle comprising:
a vehicle high-voltage system containing a high-voltage storage system according to claim 1; and
a vehicle low-voltage system having the low-voltage supply,
wherein the low-voltage supply is electrically connected to the at least one bistable contactor of the high-voltage switching device of the high-voltage storage system.

12. A motor vehicle comprising a vehicle electrical system according to claim 11.
